(19) United States
(12) Patent Application Publication
(10) Pub. No.: US 2007/0179702 A1
(43) Pub. Date: Aug. 2, 2007

(54) Combined receiver and power adapter

(75) Inventors: Clifton A. Pemble, Overland Park, KS (US); Larry G. Morse, Olathe, KS (US); Michael R. Wiegers, Paola, KS (US)

Correspondence Address: David L. Terrell;GARMIN INTERNATIONAL, INC., 1200 East 151st Street, Olathe, KS, 66062, US

(73) Assignee: GARMIN LTD., a Cayman Islands corporation

(21) Appl. No.: 11/342,092

(22) Filed: Jan. 27, 2006

(51) Int. Cl. G01C 21/34

(52) U.S. Cl. 701/200; 701/210

(57) ABSTRACT

Embodiments of the present invention provide a combined receiver and power adapter. The adapter generally includes a coupling element operable to couple with a power source, a receiver operable to wirelessly receive information, a housing operable to house the coupling element and the receiver, and a connection element operable to couple the coupling element and the receiver with an electronic device. Coupling of the connection element with the electronic device enables the adapter to provide power and/or received information to the electronic device. Such a configuration enables the electronic device to be provided with power and information without requiring the use of a plurality of cables or numerous external housings.

### BACKGROUND OF THE INVENTION

1. Field of the Invention

The present invention relates to portable electronic devices. More particularly, the invention relates to a combined receiver and power adapter operable to provide both power and received information to an electronic device.

2. Description of the Related Art

Navigation devices are becoming increasingly popular due to the many versatile functions they provide. Navigation devices typically include location determining components, such as Global Position System (GPS) receivers, and processing elements operable to provide navigation information such as desired routes of travel from current geographic locations to desired geographic locations. Thus, navigation devices are often mounted in automobiles to provide dynamic navigation information to users.

Navigation devices have also been recently provided with the ability to utilize traffic information to facilitate navigation and route planning. For example, various navigation devices are operable to utilize the Radio Data System (RDS) and/or the Radio Broadcast Data System (RBDS) to receive Traffic Message Channel (TMC) formatted information. RDS and RBDS enable TMC formatted information to be wirelessly transmitted to remote devices utilizing frequency-modulated (FM) signals.

Unfortunately, navigation devices must be equipped with FM receivers in order to receive RDS and associated TMC formatted information. Due to design and space constraints, these FM receivers often are externally coupled with navigation devices through separate cables and other connecting elements. As navigation devices also are commonly powered through automobile cigarette lighter adapters, the utilization of extra cables and housings to couple FM receivers to navigation devices reduces the aesthetic appeal of the navigation devices and restricts their functionality. Thus, users often forgo use of FM receivers and associated beneficial functionality due to their desire to limit use of additional cables and housings.

### SUMMARY OF THE INVENTION

The present invention solves the above-described problems and provides a distinct advance in the art of adapters for portable electronic devices. More particularly, the invention provides a combined receiver and power adapter operable to provide both power and received information to an electronic device. Such a configuration enables the electronic device to be provided with power and received information, such as navigation and traffic information, without requiring the use of a plurality of cables or numerous external housings.

One embodiment of the present invention provides an adapter for providing received information to an electronic device housed in a first housing. The adapter generally includes a receiver operable to wirelessly receive traffic and/or other dynamic information, a second housing to house the receiver, and a connection element secured to the second housing to provide the received traffic information to the electronic device.

In another embodiment, the adapter generally includes a coupling element operable to couple with and be at least partially inserted into an automobile cigarette lighter socket, a receiver operable to wirelessly receive traffic and/or other dynamic information, a second housing operable to house the coupling element and the receiver, and a connection element operable to couple the coupling element and the receiver with a navigation device. The receiver includes a processor operable to process the received traffic information and the connection element is operable to provide both power and processed traffic information to the navigation device.

In another embodiment, the present invention provides a navigation device housed in a first housing and an adapter housed in a second housing and operable to provide power and traffic information to the navigation device. The adapter generally includes a coupling element operable to removably couple with and be at least partially inserted into an automobile cigarette lighter socket, a receiver including an integral FM receiver and a Radio Data System (RDS) decoder to wirelessly receive and process RDS traffic information, a status indicator operable to indicate the status of the receiver, and a connection element, such as a cable including an integral antenna. The cable extends from the second housing and is operable to couple with the receiver to facilitate reception of traffic information and couple the coupling element and the receiver with the navigation device to provide power and processed RDS traffic information to the navigation device.

It should be noted that the connection element may comprise the cable, as discussed above, thereby allowing the first and second housings to be located some distance apart. Alternatively, the connection element may comprise a connector or other port designed to couple the adapter and navigation device in close proximity. In such an alternative, the coupling element may actually be located some distance from the second housing and connected thereto through a power cable including an integral antenna.

Other aspects and advantages of the present invention will be apparent from the following detailed description of the preferred embodiments and the accompanying drawing figures.

### BRIEF DESCRIPTION OF THE DRAWING FIGURES

A preferred embodiment of the present invention is described in detail below with reference to the attached drawing figures, wherein:

FIG. 1 is a front perspective view of an adapter configured in accordance with various preferred embodiments of the present invention;

FIG. 2 is a rear perspective view of the adapter of FIG. 1, the adapter shown inserted into an automobile cigarette lighter socket;

FIG. 3 is a perspective view of the adapter of FIGS. 1-2 shown coupled with a navigation device mounted to an automobile windshield;

FIG. 4 is a block diagram showing some of the elements of the adapter of FIGS. 1-3;

FIG. 5 is a block diagram of a coupling element, a receiver, and a cable utilized by the adapter of FIGS. 1-4; and

FIG. 6 is schematic diagram of a Global Positioning System (GPS) that may be utilized by various embodiments of the present invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE PREFERRED EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

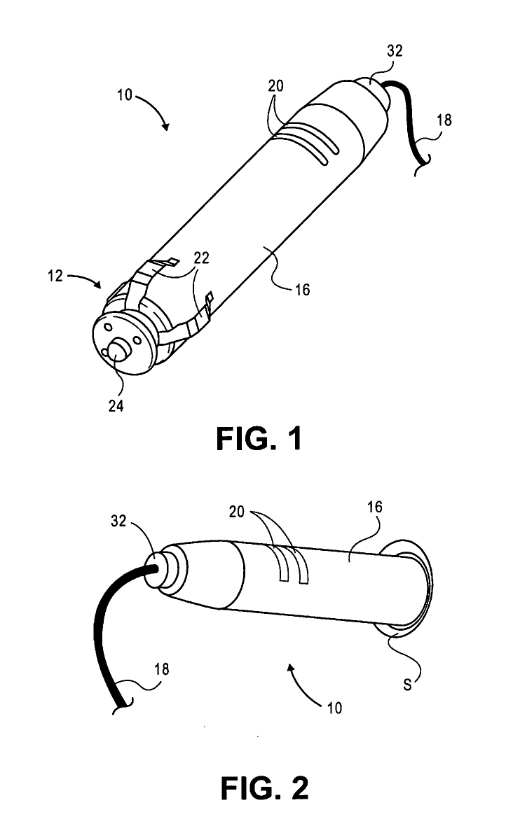

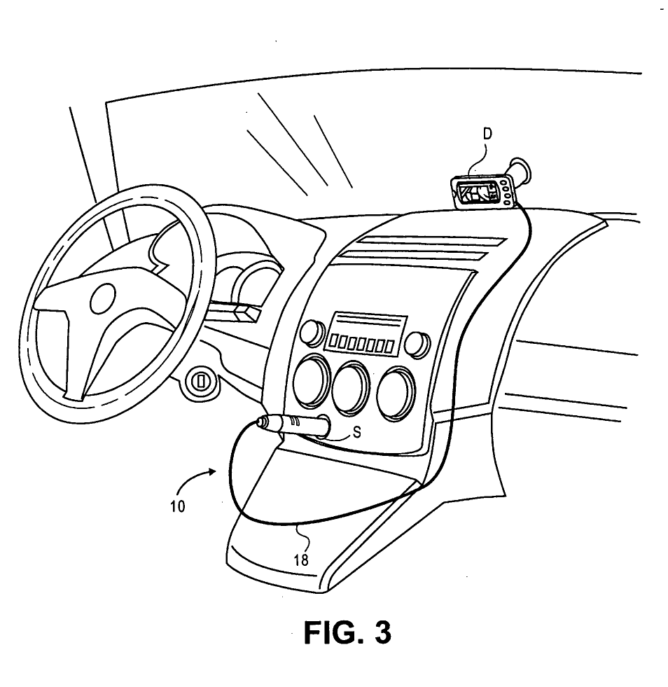

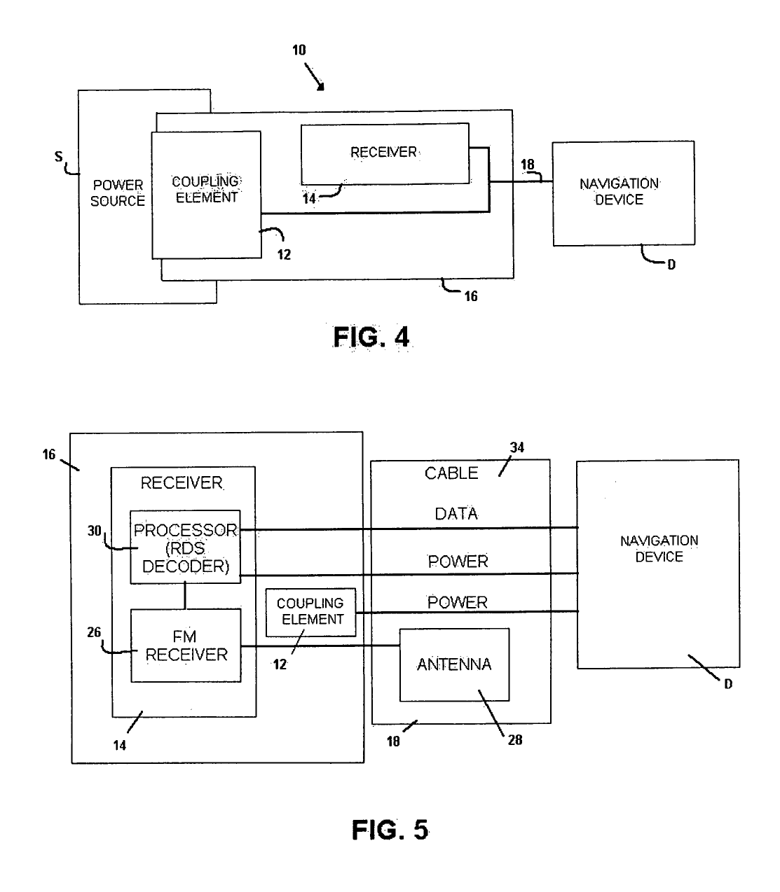

Referring to FIGS. 1-5, an adapter 10 is shown constructed in accordance with various preferred embodiments of the present invention. As is discussed in more detail below, the adapter 10 is generally operable to couple with a power source S, such as an automobile cigarette lighter socket, and an electronic device.

Preferably, the electronic device is a navigation device D, such as an automobile mounted Global Positioning System (GPS) device. However, the electronic device may be any portable electronic device, including computing devices such as portable computers and personal digital assistants (PDAs), multimedia devices such as music and video players, communication devices such as cellular phones, combinations thereof, etc.

The adapter 10 generally includes a coupling element 12 operable to couple with the power source S, a receiver 14 operable to wirelessly receive information, a housing 16 operable to house the coupling element 12 and the receiver 14, and a connection element 18 for coupling the coupling element 12 and the receiver 14 with the navigation device D. In various embodiments the adapter 10 may additionally include one or more status indicators 20 operable to indicate the status of the power source S and/or various functions of the navigation device D and adapter 10.

The coupling element 12 couples with the power source S to acquire power for utilization by the navigation device D. The coupling element 12 may be operable to couple with any source of electrical energy, including alternating and direct current sources, batteries, battery packs, two and three prong electrical sockets, various plugs and sockets, combinations thereof, etc.

Due to the wide utilization of navigation devices in automobiles, the coupling element 12 is preferably operable to couple with and be at least partially inserted into an automobile cigarette lighter socket. Thus, the coupling element 12 may employ a generally conventional cigarette lighter adapter configuration to couple with the power source S. For instance, as shown in FIG. 1, the coupling element 12 may include one or more prongs 22 and a conducting element 24 that may be at least partially inserted into the automobile cigarette light socket to receive power, specifically 12 VDC, therefrom in a generally conventional manner.

As is also shown in FIG. 1 and discussed in more detail below, the coupling element 12 and the housing 16 may present a generally continuous cylindrical profile to facilitate insertion of the coupling element 12 into the automobile cigarette lighter socket. Further, the coupling element 12 may be detachable from the housing 16 in various embodiments to facilitate use of the adapter 10.

The receiver 14 is operable to wirelessly receive information for utilization by the navigation device D. The receiver 14 may comprise any device or combination of devices operable to wirelessly receive information, including radio-frequency (RF) receivers, optical receivers, infrared receivers, wireless fidelity (WiFi) devices, ultra wideband (UWB) devices, Global System for Mobile (GSM) communication devices, Code Division Multiple Access (CDMA) devices, Worldwide Interoperability for Microwave Access (Wi-Max) devices, other 802.11 compliant devices, combinations thereof, etc.

Preferably, the receiver 14 comprises a frequency modulated (FM) receiver 26 operable for coupling with an antenna 28 to receive FM radio signals. The receiver 14 also preferably comprises a processor 30 coupled with the FM receiver 26 and operable to process received signals and information.

The FM receiver 26 and processor 30 may be integral such that a single circuit package may be utilized to both receive FM signals and process the received signals. In various embodiments, the receiver 14 may comprise a S14701 broadcast radio FM tuner, distributed by SILICON LABORATORIES, or a TEA5764 FM radio with RDS and RBDS demodulation and decoding, distributed by PHILIPS SEMICONDUCTORS. Utilization of the integral FM receiver 26 and processor 30 provides manufacturing simplicity and enables the receiver 14 to be compactly housed within the housing 16 to facilitate its use within automobiles.

Preferably, the antenna 28 is integral with the connection element 18, as is discussed in more detail below, to facilitate the reception of FM signals without requiring the utilization of a discrete, external, potentially obstructing, and aesthetically unappealing antenna. However, the antenna 28 may be integral with the FM receiver 26 to further reduce the size of the receiver 14, such as where the antenna 28 and FM receiver 26 are provided on the same integrated circuit.

Preferably, the receiver 14 is operable to receive and process traffic information, such as Traffic Message Channel (TMC) formatted information. As is known in the art, traffic data, such as road conditions, weather conditions, accident locations, areas of congestion, etc, may be provided as TMC formatted information and broadcast over conventional FM frequencies for reception by various devices. In order to broadcast TMC formatted information and associated data without interfering with audio transmissions, TMC formatted information is normally digital encoded for transmission utilizing Radio Data System (RDS) and/or Radio Broadcast Data System (RDBS) information.

Thus, the receiver 14 is preferably operable to receive FM-RDS and/or FM-RDBS information utilizing the FM receiver 26 and process the received RDS and RDBS information utilizing the processor 30. Specifically, the FM receiver 26 may receive an FM-RDS signal utilizing the antenna 28 and the processor 30 may demodulate and/or decode the received FM-RDS signal to extract or otherwise generate TMC formatted information. The TMC formatted information may include an event code and a location code operable to be provided to the navigation device D through the connection element 18 to facilitate navigation. The processor 30 may process the received signals to provide TMC formatted information utilizing any conventional method, devices, or combination of devices known by those skilled in the art.

As should be appreciated by those skilled in the art, the receiver 14 is operable to receive signals presented in any format and including any information, and need not be limited to receiving traffic information utilizing RDS or RDBS. For example, the receiver 14 may be operable to receive weather information, navigation information such as locations and destinations, entertainment information such as video and audio data, network data such as TCP/IP information, combinations thereof, etc.

The receiver 14 is preferably operable to bi-directionally communicate, such as by utilizing the RS232 standard, with the navigation device D through the connection element 18, as discussed below in more detail. In various embodiments the receiver 14 is operable to serially and asynchronously communicate with the navigation device D utilizing the connection element 18 to enable the exchange of data and information therebetween.

Further, in various embodiments the receiver 14 may be dynamically programmed by a user or by the navigation device D. Specifically, the receiver 14 may include a memory for storing user information, device information, computer programs, operational data, TMC codes, etc, which may be dynamically modified to facilitate operation of the adapter 10 and navigation device D. For example, the user may provide an access code to be stored within the memory to enable various features of the receiver 14, such as subscription based TMC or other services.

As is discussed below in more detail, the receiver 14 preferably is powered by the navigation device D through the connection element 18 and is not directly coupled with the coupling element 12 for receiving power. For instance, as discussed above, the coupling element 12 is operable to provide 12 VDC, while the receiver 14 is preferably powered by 3.3V or 5V. Thus, the coupling element 12 may provide 12 VDC, or some derivative thereof, to the navigation device D for use, while the navigation device D may utilize the power provided by the coupling element 12 to power the receiver 14 at the desired voltage or other power level. Such a configuration reduces the required size of the housing 16 and receiver 14, as various power converting elements, such as transformers, rectifiers, regulators, dividers, etc, may be housed in the navigation device instead of in the housing 16, which may therefore be more compact and less obtrusive.

However, the receiver 14 may be powered by or through other elements, such as directly from the power source S when the coupling element 12 is inserted thereto, from an internal power supply such as a battery, from an automobile power source independent of the coupling element 12, etc. Thus, the receiver 14 need not necessarily be powered through the connection element 18 by the navigation device D.

The one or more status indicators 20 are coupled with the coupling element 12 and/or the receiver 14. In various embodiments, one of the indicators 20 may be coupled with the coupling element 12 to indicate the power status of the adapter 10 or power source S. For instance, when power is provided from the power source S, the indicator may illuminate to indicate to users that the adapter 10 is active. Similarly, when power is not provided and/or when the navigation device D is operating on battery power, the indicator may be unilluminated or illuminate a second color, to indicate that the adapter 10 is not being powered by the power source S. Specifically, the second color could be used to indicate that the adapter 10 was receiving power from the navigation device D, but not the power source S. Alternatively, the indicators 20 may separately indicate power to and from the navigation device D.

The adapter 10 may include a second indicator that is operable to indicate the status of the receiver 14. For instance, when the receiver 14 is receiving information such as RDS or TMC formatted information, processing information, or otherwise providing information to the navigation device D, one of the indicators 20 may illuminate and/or flash to indicate use of the receiver 14. Such utilization of the indicators 20 facilitates use of the navigation device D by alerting users to the presence of TMC or other navigation information.

The indicators 20 are preferably prominently positioned on the housing 16 to facilitate their viewing during use of the adapter 10. For instance, as shown in FIGS. 1-3, each indicator 20 may comprise a semicircular band positioned around the housing 16 to enable each indicator 20 to be quickly viewed from various angles.

The housing 16 compactly houses various portions of the adapter 10, including the coupling element 12, the receiver 14, and the indicators 20. The housing 16 is discrete from the housing of the electronic device D. The housing 16 is preferably formed out of a rigid material, such as ABS, to provide durability and rigidity to the adapter 10. As discussed above, the housing 16 preferably presents a substantially cylindrical profile to facilitate insertion of the coupling element 12 into the power source S. As shown in FIG. 2, the cylindrical profile enables portions of the housing 16 including the coupling element 12 to be easily inserted into the cylindrical shaped automobile cigarette lighter socket without requiring precise alignment or coupling.

Additionally, the housing 16 preferably entirely encloses the receiver 14 to present an aesthetically appealing appearance. For instance, as shown in FIGS. 1-2, only the prongs 22, conducting element 24, and connection element 18 extend from an outer surface of the housing, thereby presenting a sleek, readily usable, and aesthetically pleasing housing 16.

The connection element 18 is secured to the housing 16 to provide received information to the electronic device D. Preferably, the connection element 18 is a cable 34 that extends from the housing 16 at an end opposite the coupling element 12 to facilitate insertion of the coupling element 12 into the power source S. However, the connection element 18 may be any connecting element, including a cradle, link, device, or port that couples with the electronic device D. The connection element 18 is operable to provide both power received by the coupling element 12 and navigation information received and processed by the receiver 14 to the navigation device D.

As shown in FIGS. 1-3 and 5, the cable 34 preferably presents a single and continuous sheath which encloses conductors, such as wires, for power, the antenna 28, and traffic or other dynamic information. Utilization of a single sheath to form the cable 34 reduces the number of visible wires and elements, thereby increasing the aesthetic appeal of the adapter 10 and reducing cumbersome and possibly obstructive clutter in the automobile cabin.

In various embodiments the cable 34 includes a plurality of wires to form the antenna 28, provide power to the navigation device, and to enable bi-directional communication between the receiver 14 and the navigation device D. Specifically, the cable 34 may include one wire to provide 12V from the coupling element 12 to the navigation device D, another wire to provide 3.3V from the navigation device D to the receiver 14, another wire to provide serial data from the navigation device D to the receiver 14, another write to provide serial data from the receiver 14 to the navigation device D, a wire for digital ground, a wire for device identification, a vehicle ground wire, another wire or combination of wires to form the antenna 28, etc.

The connection element 18 may be operable to directly couple with the navigation device D utilizing various connectors, ports, and other coupling elements, and/or the connection element 18 may be operable to indirectly couple with the navigation device D through other elements, such as a cradle positioned on an automobile dashboard or windshield. For example, the cable 34 may extend from the housing 16 to the cradle and the navigational device D may be removably coupled with the cradle to utilize the adapter 10. Thus, the connection element 18 and/or cable 34 need not be directly coupled with the navigation device D.

Alternatively, the housing 16 could form the cradle, thereby supporting the navigation device D. This would be especially desirable where the cradle provides other functionality to the navigation device D, such as dead reckoning information. Particularly where the housing 16 forms the cradle, the connection element 18 would preferably be a port or other connector designed to couple the adapter 10 with the navigation device D in close proximity. Here, the cable 34 could be used to connect the coupling element 12 to the adapter 10, and would therefore require fewer internal wires.

In any case, the cable preferably allows the navigation device to be mounted some distance, such as between two and six feet, from the power source S and/or receiver 14. Therefore, at least for larger vehicles, the cable is preferably approximately six feet long. However, the cable may be only four feet, or even as short as two feet, depending on the specific application. For example, where the navigation device D is to be mounted to a dashboard in close proximity to the power source S, the cable is preferably approximately two feet long. This gives adequate mounting flexibility while minimizing extraneous cable length, which detract from aesthetic appeal. However, to accommodate the largest range of mounting situations, while minimizing extraneous cable length, the preferable cable length appears to be approximately four feet.

Further, in various embodiments the connection element 18 may be removable from the housing 16 to facilitate storage of the adapter 10. For instance, when not in use, the connection element 18 may be removed from the housing 16 and stowed to limit the space occupied by the adapter 10 without having to remove the coupling element 12 from the power source S.

In such embodiments where the connection element 18 is removable or otherwise not an integral part of the adapter 10, the connection element 18 may include a contact 32 positioned on the housing 16 and coupled with the coupling element 12 and the receiver 14 for electrically and removably coupling with the connection element 18. The contact 32 may be a socket, plug, jack, receptacle, or any other conducting element operable to provide power from the coupling element 12 and navigation information from the receiver 14 to the connection element 18 and navigation device D. Thus, the contact 32 may be operable to receive a conventional cable, such as a RS232 compliant serial cable, a USB cable, a IEEE 1394 firewire cable, etc, to provide power and navigation information to the device D. However, the contact 32 may be operable to receive special purpose cables for coupling with the navigation device D.

In use, the user couples the coupling element 12 with the power source S to supply power to the navigation device. In embodiments where the power source S is an automobile cigarette lighter socket, the user may insert a portion of the housing 16 including the coupling element 12 into the socket to provide power to the navigation device D. Preferably, upon coupling the coupling element 12 with the power supply S, one of the indicators 20 is illuminated to indicate the existence of power.

The user may couple the adapter 10 with any electronic device, but the electronic device is preferably the navigation device D equipped with TMC functionality, and operable to provide, in a substantially conventional manner, geographic location information. The navigation device D may be, for example, a GPS receiver much like those provided in products by GARMIN, such as that disclosed in U.S. Pat. No. 6,434,485, which is incorporated herein by specific reference.

In general, the GPS is a satellite-based radio navigation system capable of determining continuous position, velocity, time, and direction information for an unlimited number of users. Formally known as NAVSTAR, the GPS incorporates a plurality of satellites which orbit the earth in extremely precise orbits. Based on these precise orbits, GPS satellites can relay their location to any number of receiving units.

The GPS system is implemented when a device specially equipped to receive GPS data begins scanning radio frequencies for GPS satellite signals. Upon receiving a radio signal from a GPS satellite, the device can determine the precise location of that satellite via one of different conventional methods. The device will continue scanning for signals until it has acquired at least three different satellite signals. Implementing geometrical triangulation, the receiver utilizes the three known positions to determine its own two-dimensional position relative to the satellites. Acquiring a fourth satellite signal will allow the receiving device to calculate its three-dimensional position by the same geometrical calculation. The positioning and velocity data can be updated in real time on a continuous basis by an unlimited number of users.

Although GPS enabled devices are often used to describe navigational devices, it will be appreciated that satellites need not be used to determine a geographic position of a receiving unit since any receiving device capable of receiving the location from at least three transmitting locations can perform basic triangulation calculations to determine the relative position of the receiving device with respect to the transmitting locations. For example, cellular towers or any customized transmitting radio frequency towers can be used instead of satellites. With such a configuration, any standard geometric triangulation algorithm can be used to determine the exact location of the receiving unit. Furthermore, the navigation device D could utilize dead reckoning rather than, or in support of, GPS functionality. In this way, personal hand held devices, cell phones, intelligent appliances, intelligent apparel, and others can be readily located geographically, if appropriately equipped.

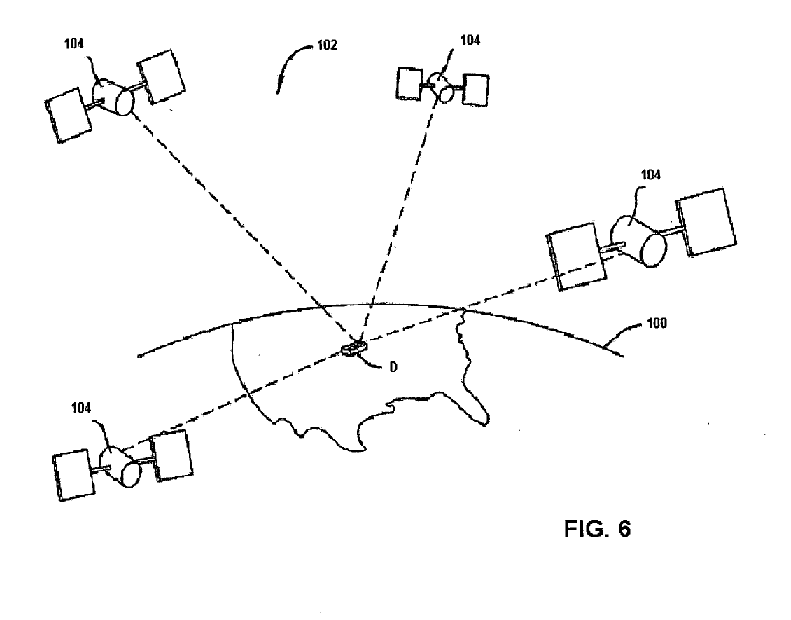

FIG. 6 shows one representative view of a GPS denoted generally by reference numeral 102. A plurality of satellites 104 are in orbit about the Earth 100. The orbit of each satellite is not necessarily synchronous with the orbits of other satellites and, in fact, is likely asynchronous. The navigation device D is shown receiving spread spectrum GPS satellite signals from the various satellites 104.

The spread spectrum signals continuously transmitted from each satellite 104 utilize a highly accurate frequency standard accomplished with an extremely accurate atomic clock. Each satellite 104, as part of its data signal transmission, transmits a data stream indicative of that particular satellite and timing information. The navigation device D must acquire spread spectrum GPS satellite signals from at least three satellites for the GPS receiver device to calculate its two-dimensional position by triangulation. Acquisition of an additional signal, resulting in signals from a total of four satellites, permits the device D to calculate its three-dimensional position.

The navigation device D may include one or more processors, controllers, or other computing devices and memory for storing information accessed and/or generated by the processors or other computing devices. The navigation device D is operable to receive GPS satellite signals from the GPS satellites 104 to calculate a position of the navigation device D as a function of the signals. The navigation device D is also operable to calculate a route to a desired location, provide instructions to navigate to the desired location, display maps and other information on a display screen, and to execute other functions described herein.

Before or after coupling the coupling element 12 with the power source S, the user may couple the connection element 18 with the navigation device D. As discussed above, the user may directly couple the connection element 18 with the navigation device D and/or the user may indirectly couple the connection element 18 with the navigation device D by coupling the connection element 18 with a cradle, or other intermediate device, and then inserting the navigation device D into the cradle. The user may detach the coupling element 12 from the power source S and the connection element 18 from the navigation device D in a substantially similar manner.

After coupling the coupling element 12 with the power source S and the connection element 18 with the navigation device D, the user may operate the navigation device D in a generally conventionally manner. Further, coupling of the apparatus 10 and the navigation device D enables the navigation device D to power the receiver 14 through the connection element 18.

The receiver 14 continuously and wirelessly receives information, such as traffic, weather, entertainment, and/or other dynamic information, that may be provided to the navigation device D for display thereon and/or to facilitate navigation. In various embodiments, the FM receiver 26 continuously receives FM-RDS and/or FM-RBDS signals and the processor 30 decodes the received signals to extract traffic information, such as TMC formatted traffic information. The traffic information is then provided to the navigation device D through the connection element 18.

The user may additionally utilize the navigation device D to configure the adapter 10. For example, the user may provide configuration information, such as user information, passwords, authorization codes, locations, performance information, etc, to the navigation device D, which is operable to bi-directionally communicate with the receiver 14 through the connection element 18. Similarly, the user may provide information and or otherwise configure the adapter 10 by wirelessly transmitting information to the receiver 14.

Upon receiving the information from the adapter 10, the navigation device D may provide an indication of the received information, calculate or process additional information based on the received information, store the received information in memory, etc. For instance, the navigation device D may display received traffic information on a display for utilization by the user and/or utilize received traffic information to perform route calculations, such as a detour around traffic congestion.

Although the invention has been described with reference to the preferred embodiment illustrated in the attached drawing figures, it is noted that equivalents may be employed and substitutions made herein without departing from the scope of the invention as recited in the claims. For instance, the adapter 10 of the present invention may be coupled with any device to provide power and wirelessly received information thereto, and need not be limited to providing traffic information to navigation devices.

Having thus described the preferred embodiment of the invention, what is claimed as new and desired to be protected by Letters Patent includes the following:

1. An apparatus for providing traffic information to an electronic device housed in a first housing, the apparatus comprising:
a receiver operable to wirelessly receive traffic information;
a second housing to house the receiver, the second housing being discrete from the first housing; and
a connection element secured to the second housing to provide the received traffic information to the electronic device.

2. The apparatus of claim 1, further including a coupling element secured to the second housing and operable to removably couple with a power source.

3. The apparatus of claim 2, wherein the connection element is further operable to provide power to the electronic device.

4. The apparatus of claim 2, wherein the second housing is operable to be at least partially inserted into an automobile cigarette lighter socket.

5. The apparatus of claim 1, wherein the connection element includes a cable operable to be coupled with the first housing.

6. The apparatus of claim 1, wherein the receiver includes a processor operable to process the received information for use by the electronic device.

7. The apparatus of claim 1, wherein the traffic information corresponds to Radio Data System (RDS) traffic information.

8. The apparatus of claim 7, wherein the receiver includes a RDS decoder for decoding the RDS information.

9. The apparatus of claim 1, wherein the receiver is operable to be powered by the electronic device through the connection element.

10. The apparatus of claim 1, wherein the receiver is selected from the group consisting of a FM receiver, an optical receiver, an infrared receiver, a wireless fidelity (WiFi) device, an ultra wideband (UWB) device, a Global System for Mobile (GSM) communication device, a Code Division Multiple Access (CDMA) device, and a Worldwide Interoperability for Microwave Access (Wi-Max) device.

11. The apparatus of claim 1, wherein the connection element includes an integral antenna operable to couple with the receiver to facilitate reception of the traffic information.

12. An adapter for providing power and information to a navigation device housed in a first housing, the adapter comprising:
a coupling element operable to removably couple with and be at least partially inserted into an automobile cigarette lighter socket;
a receiver operable to wirelessly receive information, the receiver including a processor operable to process the received information;
a second housing to house the coupling element and the receiver, the second housing being discrete from the first housing; and
a cable extending from the second housing and operable to couple the coupling element and the receiver with the first housing to provide power and processed information to the navigation device.

13. The adapter of claim 12, wherein the received information includes Radio Data System (RDS) information.

14. The adapter of claim 13, wherein the receiver includes an FM receiver and the processor includes a RDS decoder.

15. The adapter of claim 14, wherein the FM receiver and the processor are integral.

16. The adapter of claim 12, wherein the receiver receives power from the navigation device through the cable.

17. The adapter of claim 12, further including a status indicator operable to indicate the status of the receiver.

18. The adapter of claim 12, wherein the cable includes an integral antenna operable to couple with the receiver to facilitate reception of the information.

19. An apparatus comprising:
a navigation device housed in a first housing; and
an adapter including—
a coupling element operable to removably couple with and be at least partially inserted into an automobile cigarette lighter socket;
a receiver including an integral FM receiver and a Radio Data System (RDS) decoder, the receiver operable to wirelessly receive and process RDS traffic information;
a status indicator operable to indicate the status of the receiver;
a second housing operable to house the coupling element, the receiver, and the status indicator, the second housing being discrete from the first housing; and
a cable including an integral antenna, the cable extending from the second housing and operable to—
couple with the receiver to facilitate reception of traffic information, and
couple the coupling element and the receiver with the navigation device to provide power and processed RDS traffic information to the navigation device.

20. The apparatus of claim 19, wherein the receiver is powered by the navigation device through the cable.

21. The apparatus of claim 19, wherein the RDS traffic information includes traffic message channel (TMC) formatted information.

22. The apparatus of claim 19, wherein the navigation device is operable to perform a route calculation utilizing the received traffic information.

23. An adapter for providing power and traffic information to a navigation device housed in a first housing, the adapter comprising:
a coupling element operable to removably couple with and be at least partially inserted into an automobile cigarette lighter socket;
a receiver operable to wirelessly receive traffic information, the receiver including a processor operable to process the received traffic information;
a second housing to house the receiver, the second housing being discrete from the first housing; and
a connecting element secured to the second housing and operable to couple with the navigation device to provide power and processed traffic information to the navigation device.

24. The adapter of claim 23, wherein the received traffic information includes Radio Data System (RDS) information.

25. The adapter of claim 23, wherein the receiver receives power from the navigation device through the connecting element.

26. The adapter of claim 23, further including a status indicator operable to indicate the status of the receiver.

27. The adapter of claim 23, wherein the connection element includes a cable operable to be coupled with the first housing.

28. The adapter of claim 27, wherein the connecting element includes an integral antenna operable to couple with the receiver to facilitate reception of the information.

29. The adapter of claim 23, further including a cable to couple the coupling element with the second housing.

30. The adapter of claim 29, wherein the cable includes an integral antenna operable to couple with the receiver to facilitate reception of the information.
